(19) United States
(12) Patent Application Publication
(10) Pub. No.: US 2021/0164882 A1
(43) Pub. Date: Jun. 3, 2021

(54) SAMPLE LIQUID-SENDING DEVICE, FLOW CYTOMETER, AND SAMPLE LIQUID-SENDING METHOD

(71) Applicant: SONY CORPORATION, TOKYO (JP)

(72) Inventor: KATSUTOSHI TAHARA, TOKYO (JP)

(21) Appl. No.: 17/250,466

(22) PCT Filed: May 13, 2019
(86) PCT No.: PCT/JP2019/018900

§ 371 Date: Jan. 25, 2021

(30) Foreign Application Priority Data
Aug. 1, 2018 (JP) 2018-145191

(51) Int. Cl. G01N 15/14

(52) U.S. Cl. CPC G01N 15/1404

(57) ABSTRACT

A sample liquid-sending device of the present technology includes a drive mechanism, a suction mechanism, and a controller. The drive mechanism supports a sample container and is configured to be capable of moving the sample container, the sample container including a storing portion that stores a suspension containing a sample. The suction mechanism includes a nozzle configured to be inserted into the storing portion, and suctions the suspension through the nozzle. The controller is configured to be capable of controlling the drive mechanism such that a bottom of the storing portion and a suction port of the nozzle are separated from each other by a predetermined distance.

### TECHNICAL FIELD

The present technology relates to a flow cytometer, and a sample liquid-sending device and a sample liquid-sending method that are used in the flow cytometer.

### BACKGROUND ART

A flow cytometer flows a sample suspended in liquid through a tube using a sheath liquid, acquires data of scattered light and fluorescence obtained by a laser irradiator provided midway in the flow, and analyzes the data. For example, Patent Literature 1 discloses a sample liquid-sending device in a flow cytometer, the sample liquid-sending device including a stirring unit for performing stirring in a sample tube, and a nozzle that suctions a sample in the sample tube. Stirring is performed in the sample tube using the stirring unit, and thus the nozzle inserted into the sample tube serves as a stirring rod that moves relative to the sample tube (for example, refer to paragraphs [0014] and [0049] of the specification, and FIG. 1). Performing stirring in a sample tube leads to dispersing, in liquid, the precipitate of the sample accumulated at the bottom of the sample tube, and delivering the sample efficiently.

### CITATION LIST

### Patent Literature

Patent Literature 1: Japanese Patent Application Laid-open No. 2016-153805

### DISCLOSURE OF INVENTION

### Technical Problem

As described above, there is a demand for a technique capable of sufficiently suctioning the precipitate of the sample accumulated at the bottom of the sample tube.

In view of the circumstances described above, it is an object of the present technology to provide a sample liquid-sending device capable of sufficiently suctioning a precipitate of a sample, a flow cytometer including the sample liquid-sending device, and a sample liquid-sending device method therefor.

### Solution to Problem

In order to achieve the object described above, a sample liquid-sending device according to an embodiment of the present technology includes a drive mechanism, a suction mechanism, and a controller.

The drive mechanism supports a sample container and is configured to be capable of moving the sample container, the sample container including a storing portion that stores a suspension containing a sample.

The suction mechanism includes a nozzle configured to be inserted into the storing portion, and suctions the suspension through the nozzle.

The controller is configured to be capable of controlling the drive mechanism such that a bottom of the storing portion and a suction port of the nozzle are separated from each other by a predetermined distance.

According to this configuration, the sample container can be moved relative to the nozzle. This makes it possible to set the distance between the bottom of the storing portion and the suction port of the nozzle such that the precipitate of the sample can be sufficiently suctioned. Thus, according to the present technology, it is possible to sufficiently suction the precipitate of the sample accumulated at the bottom of the storing portion.

The controller may control a distance between the bottom and the suction port to be 0.4 mm or more and 0.8 mm or less.

The suction mechanism may include the nozzle including a hollow portion and an opening, the hollow portion being a flow path through which the suspension flows, the opening being provided in the suction port and communicating with the hollow portion. This makes it possible to suction the suspension while the suction port of the nozzle and the bottom of the well are in contact with each other, and to suction the suspension sufficiently.

The suction mechanism may include the nozzle including a plurality of openings provided in the suction port and communicating with the hollow portion. This improves the efficiency in suctioning the suspension.

The suction mechanism may include the nozzle including a notched bottom surface facing the bottom. With this configuration, a gap is formed between the tip of the suction port and the bottom of the storing portion when the suction port is accommodated in the storing portion that does not have a flat bottom, so that a flow path for suctioning the suspension is reliably secured. Thus, it is possible to sufficiently suction the suspension accumulated at the bottom of the storing portion.

The sample liquid-sending device may further include a holding mechanism including a detection unit that detects a contact between the bottom and the suction port, and capable of holding the nozzle at a predetermined position. This makes it possible to freely determine a relative position of the storing portion with respect to the nozzle.

In order to achieve the object described above, a flow cytometer according to an embodiment of the present technology includes the sample liquid-sending device described above, a holding mechanism, and an analysis unit.

The holding mechanism includes a detection unit that detects a contact between the bottom and the suction port, and is configured to be capable of holding the nozzle at a predetermined position.

The analysis unit analyzes a characteristic of the sample.

In order to achieve the object described above, a sample liquid-sending method according to an embodiment of the present technology includes: inserting a nozzle provided to a suction mechanism into a storing portion of a sample container supported by a drive mechanism, a suspension containing a sample being stored in the storing portion; separating a bottom of the storing portion and a suction port of the nozzle from each other by a predetermined distance; and suctioning the suspension through the nozzle by the suction mechanism.

In order to achieve the object described above, a sample liquid-sending method according to an embodiment of the present technology includes: inserting a nozzle provided to a suction mechanism into a storing portion of a sample container supported by a drive mechanism, a suspension containing a sample being stored in the storing portion; detecting a contact between a bottom of the storing portion and a suction port of the nozzle; and suctioning the suspension through the nozzle by the suction mechanism in a state where the bottom and the suction port are in contact with each other.

### Advantageous Effects of Invention

As described above, according to the present technology, it is possible to sufficiently suction the precipitate of the sample. Note that the above effects are not necessarily limited, and any of the effects shown in the specification or other effects that can be grasped from the present specification may be achieved together with the above effects or in place of the above effects.

### BRIEF DESCRIPTION OF DRAWINGS

FIG. 1 is a schematic diagram mainly showing a sample liquid-sending device according to a first embodiment of the present technology, and schematically showing a configuration example of a flow cytometer including the sample liquid-sending device.

FIG. 2 is a schematic diagram showing a configuration example of a holding mechanism of the sample liquid-sending device.

FIG. 3 is a schematic diagram showing a configuration example of the holding mechanism.

FIG. 4 is a schematic diagram showing a configuration example of the holding mechanism.

FIG. 5 is a schematic diagram showing a configuration example of the holding mechanism.

FIG. 6 is a schematic diagram showing a configuration example of the holding mechanism.

FIG. 7 is a schematic diagram showing a configuration example of the holding mechanism.

FIG. 8 is a schematic diagram showing a configuration example of the holding mechanism.

FIG. 9 is a flowchart showing an operation procedure of the sample liquid-sending device.

FIG. 10 is a graph showing a relationship between an event rate and a distance from a suction port of a nozzle and a bottom of a well.

FIG. 11 is an enlarged diagram of the suction port of the nozzle according to a second embodiment of the present technology, showing a variation of the formation pattern of an opening provided in the suction port.

FIG. 12 is a diagram showing a variation of the formation pattern of the opening.

FIG. 13 is a diagram showing a variation of the formation pattern of the opening.

FIG. 14 is a diagram showing a variation of the formation pattern of the opening.

FIG. 15 is an enlarged diagram of a bottom surface of the nozzle, showing a variation of the formation pattern of the bottom surface.

FIG. 16 is an enlarged perspective diagram of the vicinity of the suction port, showing a nozzle accommodated in a storing portion.

FIG. 17 is a diagram showing a variation of the formation pattern of the bottom surface.

FIG. 18 is a diagram showing a variation of the formation pattern of the opening.

FIG. 19 is a diagram showing a variation of the formation pattern of the opening.

FIG. 20 is a diagram showing a variation of the formation pattern of the opening.

FIG. 21 is a table showing comparison between a dead volume in the case of using a conventional nozzle and a dead volume in the case of using the nozzle of the second embodiment.

FIG. 22 is a graph showing the time change of the event rate when using the nozzle of the second embodiment.

### MODE(S) FOR CARRYING OUT THE INVENTION

Hereinafter, embodiments of the present technology will be described with reference to the drawings.

### 1. First Embodiment

1.1) Configuration of Flow Cytometer

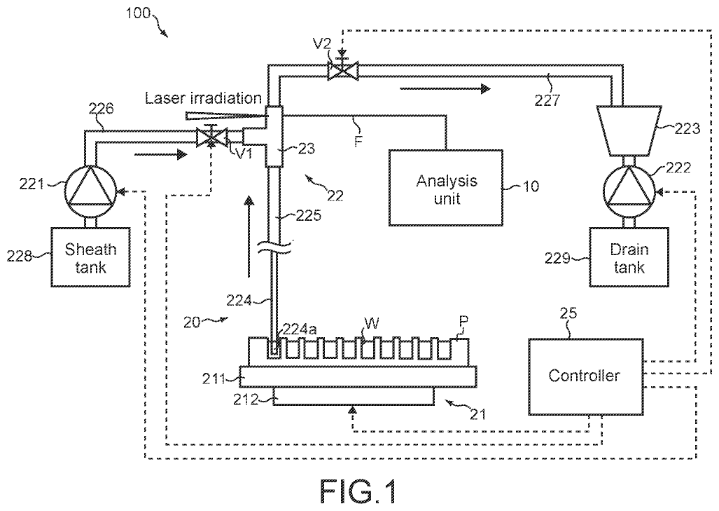

FIG. 1 is a schematic diagram schematically showing a configuration example of a flow cytometer 100 according to a first embodiment. The flow cytometer 100 includes an analysis unit 10 and a sample liquid-sending device 20.

[Analysis Unit]

The analysis unit 10 has a function of analyzing the characteristics of a sample detected in the sample liquid-sending device 20. That is, the flow cytometer 100 of this embodiment typically functions as an analyzer.

The analysis unit 10 is connected to a sample detection unit 23 by, for example, an optical fiber F. The analysis unit 10 has a function of analyzing optical characteristics of scattered light generated by laser irradiation, fluorescence, and the like. The analysis unit 41 is typically configured by a computer.

[Sample Liquid-Sending Device]

The sample liquid-sending device 20 includes a drive mechanism 21, a suction mechanism 22, the sample detection unit 23, a holding mechanism 24, and a controller 25.

(Drive Mechanism)

The drive mechanism 21 includes a support portion 211 and a drive unit 212. The support portion 211 supports a well plate P (sample container). The drive unit 212 is configured to be capable of moving the well plate P in a longitudinal direction of a nozzle 224 and a plane direction orthogonal to the longitudinal direction via the support portion 211. That is, the drive unit 212 is configured to be capable of moving the well plate P in three axial directions orthogonal to each other via the support portion 211.

As the drive unit 212, for example, a cylinder mechanism is employed. In this case, the drive unit 212 typically has an air cylinder mechanism, but is not limited thereto. Any mechanism of a dry cylinder type, a gas cylinder type, an oil cylinder type, and the like may be used.

As shown in FIG. 1, the well plate P includes a plurality of wells W (storing portions). Each of the plurality of wells W stores a suspension containing a sample. The sample is, for example, a biological cell. The inner diameter of the well W is not particularly limited, but is approximately 8 to 9 mm, for example.

The well plate P is, for example, a 6, 12, 24, 48, 96, or 384 well plate, but a 96 well plate is typically employed. The well plate P is made of a synthetic resin such as plastic, for example. Note that in this embodiment, the well plate P is supported by the support portion 211, but the present technology is not limited thereto. For example, one or more sample tubes may be supported.

(Suction Mechanism)

The suction mechanism 22 includes pumps 221 and 222, a nozzle 224, a sample flow tube 225, a sheath flow tube 226, a junction tube 227, a sheath tank 228, and a drain tank 229.

A sheath liquid is stored in the sheath tank 228. The sheath liquid is liquid that serves to squeeze and focus the flow of the sample in the flow cytometer 100. As the sheath liquid, for example, water, physiological saline, or the like is employed.

The pump 221 is connected to the sheath flow tube 226 and the sheath tank 228 in the upstream of the flow cytometer 100. The pump 221 has a function of suctioning the sheath liquid from the sheath tank 228 and transferring the suctioned sheath liquid to the downstream side.

The pump 222 is connected to the junction tube 227 and the drain tank 229 on the downstream side of the flow cytometer 100. The pump 222 has a function of suctioning a mixed solution of the sheath liquid and the suspension from the upstream side and discharging the suctioned mixed solution to the drain tank 229.

In this embodiment, as shown in FIG. 1, the two pumps 221 and 222 are respectively provided on the upstream side and downstream side of the flow cytometer 100. Driving pressures and driving timings of the pumps, timings for opening and closing valves V1 and V2, or the like are controlled, so that the flow of the liquid flowing through the sheath flow tube 226, the sample flow tube 225, the sample detection unit 23, and the junction tube 227 is precisely controlled.

The nozzle 224 has a suction port 224a. The sample liquid-sending device 20 suctions the suspension stored in the well W of the well plate P through the nozzle 224 (suction port 224a). At that time, the suction port 224a is accommodated in the well W.

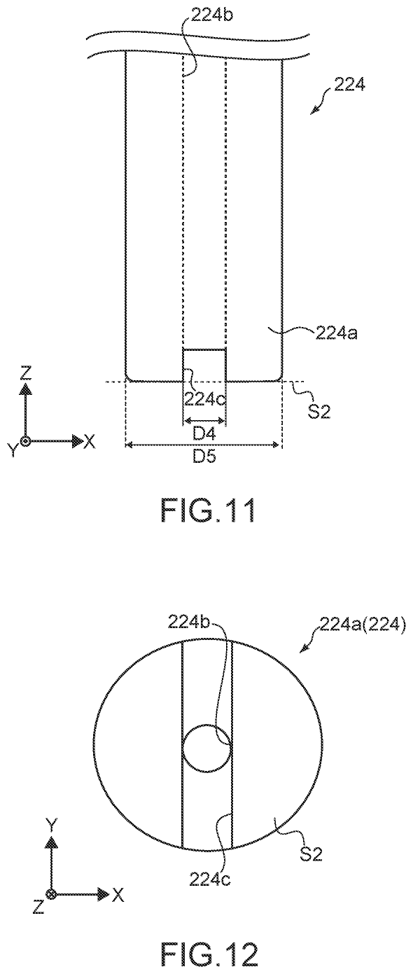

An inner diameter D4 and an outer diameter D5 of the nozzle 224 are not particularly limited. For example, the inner diameter D4 (the diameter of a hollow portion 224b) is approximately 0.2 mm, and the outer diameter D5 is approximately 1.6 mm (see FIG. 11). The material of the nozzle 224 is not particularly limited, and, for example, stainless steel or the like can be employed. The detailed configuration of the nozzle 224 will be described in a second embodiment to be described later.

The sample flow tube 225 connects the nozzle 224 and the sample detection unit 23. Part or all of the sample flow tube 225 is made of a flexible material such as a silicon rubber.

The sheath flow tube 226 connects the pump 221 and the sample detection unit 23. The sheath flow tube 226 includes the valve V1. The junction tube 227 connects the sample detection unit 23 and the pump 222 (a buffer 223 provided on the more upstream side). The junction tube 227 includes the valve V2. The valves V1 and V2 are typically opening and closing valves such as on-off valves, and include solenoid valves or pneumatic valves, for example.

(Sample Detection Unit)

As shown in FIG. 1, the sample detection unit 23 is connected to the sheath flow tube 226, the sample flow tube 225, and the junction tube 227. The sample detection unit 23 has a function of forming a sheath flow with the sheath liquid coming from the sheath tank 228 and detecting samples.

The sample detection unit 23 mainly includes a cuvette. In the sample liquid-sending device 20, the sheath flow of the sheath liquid is formed in this cuvette, and thus samples from the sample flow tube 225 flow in line. Here, in this embodiment, samples (e.g., biological cells) flowing in line in this cuvette are irradiated with a laser beam from a laser generator (not shown) and thus detected.

Typically, the sample detection unit 23 of this embodiment mainly incudes a cuvette, but it is not limited thereto. The sample detection unit 23 may be, for example, a sorting chip. As such a sorting chip, for example, one having an orifice size of 70 μm, 100 μm, or 130 μm is employed.

(Holding Mechanism)

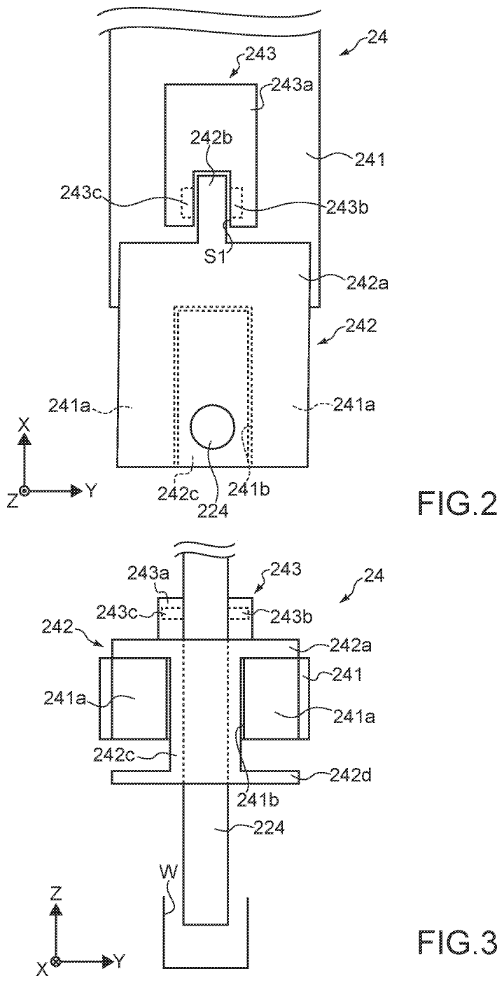

FIGS. 2 to 8 are schematic diagrams each showing a configuration example of the holding mechanism 24. Hereinafter, some configuration examples of the holding mechanism 24 will be described. Note that the X-, Y-, and Z-axis directions shown in those figures represent three mutually orthogonal axes, which are common to all the figures in this specification.

### Configuration Example 1

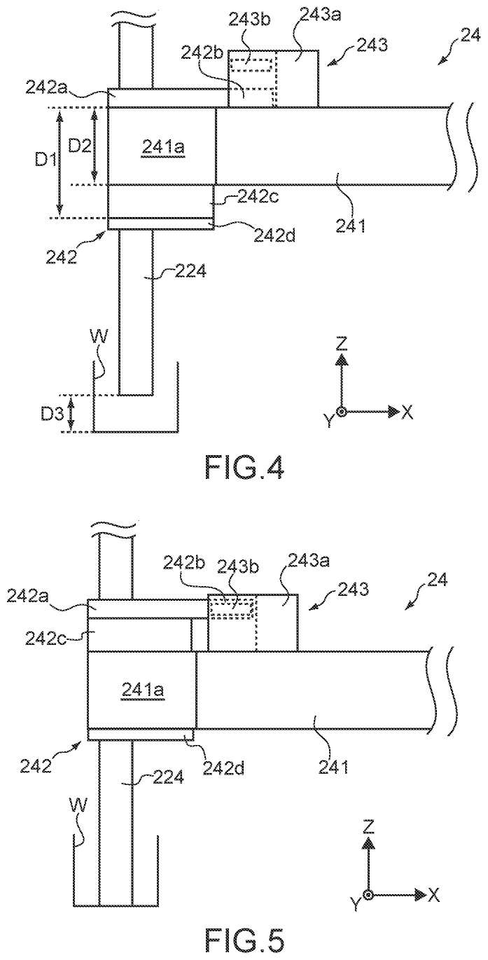

FIG. 2 is a top view of the holding mechanism 24, FIG. 3 is a front view of the holding mechanism 24 in the bottom dead center state (initial state), FIG. 4 is a side view of FIG. 3, and FIG. 5 is a side view of the holding mechanism 24 in the top dead center state. The holding mechanism 24 includes a nozzle arm 241, a nozzle holder 242, and a collision sensor 243 (detection unit).

The nozzle holder 242 is configured to support the nozzle 224 and to be movable in the Z-axis direction relative to the nozzle arm 241. Thus, the nozzle 224 moves in the Z-axis direction together with the nozzle holder 242.

The nozzle holder 242 includes a first flat plate portion 242a, a second flat plate portion 242d, and a coupling portion 242c. The first flat plate portion 242a is placed on the upper surface of the nozzle arm 241 in the vertical direction when the holding mechanism 24 is in the bottom dead center state (see FIG. 4). That is, the state in which the first flat plate portion 242a and the nozzle arm 241 is in contact with each other is the bottom dead center state of the holding mechanism 24. The first flat plate portion 242a protrudes from the second flat plate portion 242d toward the collision sensor 243 in the X-axis direction.

Further, the first flat plate portion 242a of this embodiment has a protrusion 242b protruding in the X-axis direction at the center in the Y-axis direction. As shown in FIG. 2, the protrusion 242b enters a portion of the collision sensor 243.

The second flat plate portion 242d is placed on a holding portion 241a of the nozzle arm 241 when the holding mechanism 24 is in the top dead center state (see FIG. 5). That is, the state in which the second flat plate portion 242d and the holding portion 241a is in contact with each other is the bottom dead center state of the holding mechanism 24. The second flat plate portion 242d functions as a stopper for restricting the movement of the nozzle holder 242 in the Z-axis direction.

The coupling portion 242c connects the first flat plate portion 242a and the second flat plate portion 242d. As shown in FIG. 3, the coupling portion 242c is disposed between the pair of holding portions 241a. The coupling portion 242c is configured to be movable in the Z-axis direction while facing the holding portions 241a in the Y-axis direction.

The nozzle arm 241 holds the nozzle 224 through the nozzle holder 242. The nozzle arm 241 is configured to be capable of holding the nozzle holder 242 (coupling portion 242c) at an any position in the Z-axis direction. Thus, the nozzle holder 242 is held (fixed) at a predetermined position by the nozzle arm 241, and thus it is possible to freely determine a relative position of the well W with respect to the nozzle 224. The nozzle arm 241 includes the pair of holding portions 241a facing both side surfaces of the coupling portion 242c in the Y-axis direction and protruding in the X-axis direction.

In the nozzle arm 241, the pair of holding portions 241a and the end surface facing in the X-axis direction between the holding portions 241a constitute an opening 241b. As shown in FIGS. 2 and 3, the opening 241b accommodates the coupling portion 242c at predetermined intervals.

A width D2 of the holding portion 241a in the Z-axis direction is configured to be narrower than a width D1 of the coupling portion 242c in the Z-axis direction. This creates a backlash when the nozzle holder 242 moves in the Z-axis direction.

The collision sensor 243 includes a housing 243a, an LED light source 243b, and a photodiode 243c. As shown in FIGS. 4 and 5, the housing 243a is provided on the nozzle arm 241 and has an opening S1 that is opened toward the nozzle 224. The opening S1 accommodates one end of the protrusion 242b of the first flat plate portion 242a.

The LED light source 243b and the photodiode 243c are provided in the housing 243a so as to face each other in the Y-axis direction through the opening S1, and are provided at respective positions facing one end of the protrusion 242b in the Y-axis direction when the holding mechanism 24 is in the top dead center state (see FIG. 5).

The collision sensor 243 is configured to be capable of detecting the contact (touch) between the suction port 224a of the nozzle 224 and the bottom of the well W and outputting a detection signal based on the detection result to the controller 25, in response to that the emitted light of the LED light source 243b is blocked by the protrusion 242b and that the photodiode 243c does not receive the emitted light.

For the collision sensor 243 of this embodiment, a transmissive photosensor is typically employed, but the present technology is not limited thereto. For example, a reflective photosensor may be employed.

### Configuration Example 2

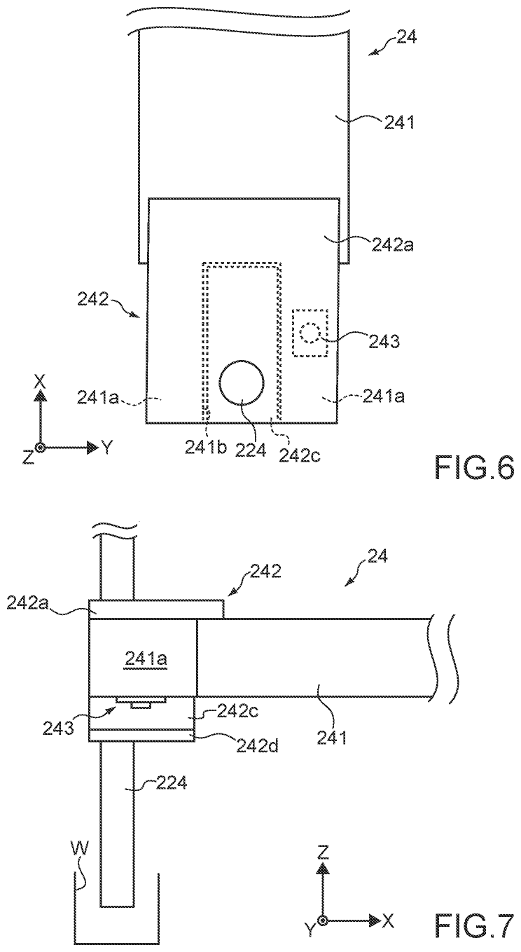

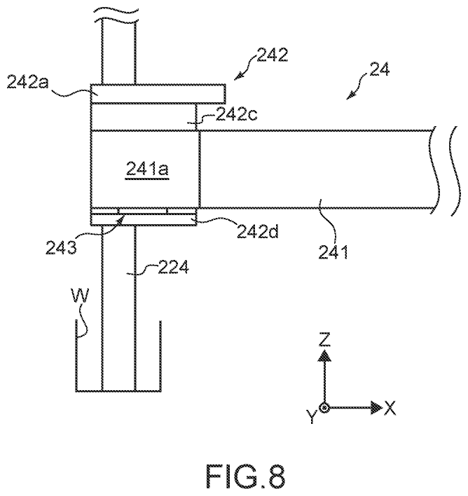

Next, another configuration example of the holding mechanism 24 will be described. FIG. 6 is a top view of the holding mechanism 24, FIG. 7 is a side view of the holding mechanism 24 in the bottom dead center state (initial state), and FIG. 8 is a side view of the holding mechanism 24 in the top dead center state. Note that similar reference symbols are assigned to the similar configurations as in the configuration example 1, and description thereof will be omitted.

As shown in FIGS. 7 and 8, the collision sensor 243 of this embodiment may be a switch-type collision sensor. In this case, the collision sensor 243 is provided to the holding portion 241a so as to face the second flat plate portion 242d.

Thus, the collision sensor 243 is configured to detect, when pressed by the second flat plate portion 242d in the top dead center state of the holding mechanism 24, a contact between the bottom of the well W and the suction port 224a of the nozzle 224 and to output a detection signal based on the detection result to the controller 25. Note that the configurations of the holding mechanism 24 shown in FIGS. 2 to 8 are merely an examples, and the present technology is not limited to the configurations shown in those figures.

(Controller)

The controller 25 is configured to control the drive of the pumps 221 and 222, the drive mechanism 21 (drive unit 212), the valves V1 and V2, and other mechanisms. In particular, the controller 25 is configured to be capable of controlling the drive unit 212 such that the bottom of the well W and the suction port 224a of the nozzle 224 are separated from each other by a predetermined distance. The controller 25 basically includes, in addition to the drivers of those components, hardware necessary for a computer such as a central processing unit (CPU), a random access memory (RAM), and a read only memory (ROM).

The controller 25 may include a programmable logic device (PLD) such as a field programmable gate array (FPGA) instead of the CPU. Further, the controller 25 includes the drivers (not shown) for driving the pumps 221 and 222, the drive mechanism 21, the valves V1 and V2, and the like.

1.2) Operation of Sample Liquid-Sending Device

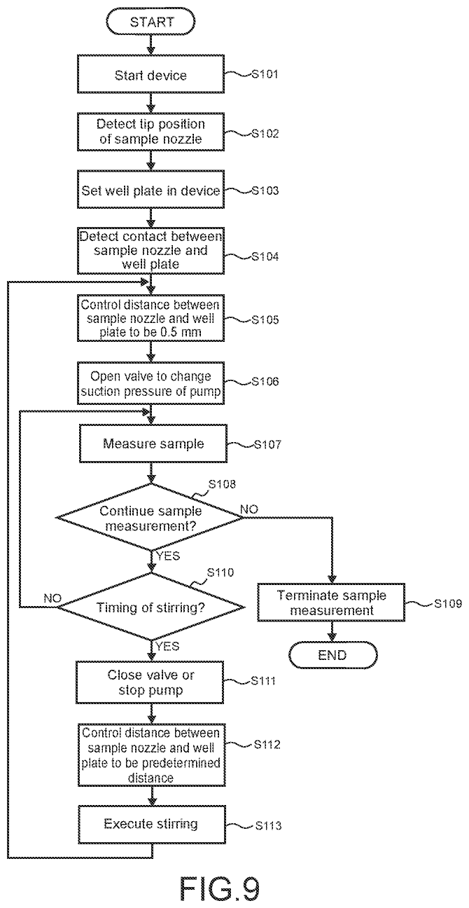

FIG. 9 is a flowchart showing an operation procedure of the sample liquid-sending device 20. Hereinafter, a typical operation of the sample liquid-sending device 20 of this embodiment will be described with reference to FIG. 9 as appropriate.

First, the sample liquid-sending device 20 is started (Step S101) to detect the tip position of the nozzle 224 (Step S102). As a result, it is possible to grasp how far the suction port 224a of the nozzle 224 and the support portion 211 are separated from each other. The method of detecting the tip position of the nozzle 224 is not particularly limited, and for example, a position detection sensor or the like may be employed.

Next, the well plate P is set in the support portion 211 (Step S103), and the controller 25 moves the drive unit 212 toward the nozzle 224 in a stepwise manner. As a result, the well plate P approaches the nozzle 224 in a stepwise manner, and the bottom of the well W comes into contact with the suction port 224a of the nozzle 224. At that time, it is favorable that the moving distance of the well plate P per step is approximately 0.1 mm. As a result, the suction port 224a and the bottom of the well W are prevented from abutting on each other with an excessive force.

Next, the controller 25 further raises the drive unit 212 from the state in which the suction port 224a and the bottom of the well W are in contact with each other, and the second flat plate portion 242d comes into contact with the nozzle arm 241. As a result, the holding mechanism 24 shifts from the bottom dead center state to the top dead center state, and the top dead center state is maintained by the nozzle arm 241 holding the coupling portion 242c.

At that time, depending on whether the emitted light of the LED light source 243b is blocked by the protrusion 242b (see FIG. 5) or the collision sensor 243 is pressed by the second flat plate portion 242d (see FIG. 8), the collision sensor 243 detects the contact between the bottom of the well W and the suction port 224a (Step S104), and outputs a detection signal based on the detection result to the controller 25. Note that the moving distance of the first flat plate portion 242a when the holding mechanism 24 shifts from the bottom dead center state to the top dead center state is approximately 0.4 mm.

Next, in response to obtaining the detection signal from the collision sensor 243, the controller 25 moves the drive unit 212 in a direction separating from the nozzle 224 by a predetermined distance. As a result, the suction port 224a and the bottom of the well W are separated from each other by a predetermined distance. At that time, a distance D3 between the suction port 224a and the bottom of the well W is not particularly limited, but it is typically controlled to be 0.5 mm by the controller 25 (Step S105).

Subsequently, the controller 25 opens the valves V1 and V2 to change the suction pressures of the pumps 221 and 222 (Step S106). As a result, the suction mechanism 22 suctions the suspension in the well W via the nozzle 224, and further suctions the sheath liquid in the sheath tank 228. Then, the suspension and the sheath liquid merge in the sample detection unit 23, and the mixed liquid of them is transferred toward the drain tank 229. At that time, the mixed liquid flowing in the sample detection unit 23 is irradiated with a laser beam, and thus the sample measurement is performed (Step S107). The sample measurement time is not particularly limited, but it is typically one second.

Next, if the sample measurement is to be continued (YES in Step S108) and when the timing of stirring the suspension in the well W comes (YES in Step S110), the controller 25 stops the pumps 221 and 222 or closes the valves V1 and V2. Thus, the pressure in the nozzle 224 is set to zero (Step S111).

Next, the controller 25 moves the drive unit 212 in a direction separating from the nozzle 224 by a predetermined distance. As a result, the suction port 224a and the bottom of the well W are further separated from each other by a predetermined distance. Although the distance D3 between the suction port 224a and the bottom of the well W is not particularly limited at that time, the distance D3 is controlled to be approximately 80 mm by the controller 25 if the suspension in the well W is swung and stirred in Step S113 to be described later, and is controlled to be approximately 1.4 mm by the controller 25 if the suspension is stirred by the nozzle 224.

Subsequently, in a state where the suction port 224a and the bottom of the well W are separated from each other by a predetermined distance, the suspension in the well W is stirred under the control of the controller 25. At that time, stirring by swinging such as moving the drive mechanism 21 that supports the well plate P may be executed. Alternatively, vibrations may be generated by a vibrator (not shown) attached to the holding mechanism 24 to cause the nozzle 224 to stir the suspension.

In this embodiment, a series of operations from Step S104 to Step S113 (S104→S105→S106→S107→S108→S110→S111→S112→S113) is repeated for one well W until the sample measurement is finished.

Meanwhile, if the sample measurement is not to be continued (NO in Step S108), the controller 25 closes the valves V1 and V2 or stops the pumps 221 and 222, thus terminating the sample measurement (Step S109). Further, if the timing of stirring the suspension in the well W does not come (NO in Step S110), the sample measurement is continuously performed.

In this embodiment, the series of operations from Step S104 to Step S113 described above is executed for all the wells W provided in the well plate P.

1.3) Verification

In order to confirm the effect of the first embodiment, the inventor conducted the following verification. In this verification, the inventor used a cell analyzer (product name: SA3800) manufactured by Sony Corporation.

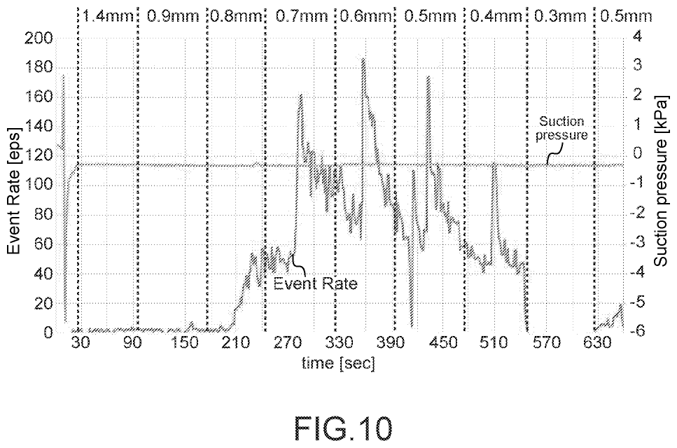

The inventor has confirmed an event rate (events per second; eps) while changing the distance D3 between the bottom of the well W and the suction port 224a of the nozzles 224 within the range of 0.3 mm or more and 1.4 mm or less under a constant suction pressure. FIG. 10 is a graph showing results of the verification. In this case, a suspension in which sample beads (flow check beads) of a dried inorganic material are precipitated as samples in deionized water (DIW) is stored in the well W. Further, the event rate is the number of samples detected by the sample detection unit 23 per second. In addition, in this verification, the flow rate at which the suspension is suctioned was set to 33 μL/min.

Referring to FIG. 10, when the distance D3 between the bottom of the well W and the suction port 224a is in the range of 0.9 mm or more and 1.4 mm or less, the event rate is hardly confirmed. That is, the precipitate of the samples accumulated at the bottom of the well W is hardly suctioned. This may be because the distance D3 between the bottom of the well W and the suction port 224a is excessively large.

On the other hand, when the distance D3 between the bottom of the well W and the suction port 224a is in the range of 0.4 mm or more and 0.8 mm or less, the event rate was confirmed, and a large event rate was confirmed particularly in the range of 0.4 mm or more and 0.7 mm or less.

However, when the distance D3 between the bottom of the well W and the suction port 224a was 0.3 mm, the event rate was not confirmed. That is, when the distance D3 was set to 0.3 mm or less, it was confirmed that the precipitate of the samples was not suctioned. This may be because a pressure loss occurs due to an excessively small distance D3 between the bottom of the well W and the suction port 224a.

Referring to FIG. 10, since the event rate was confirmed again when the distance D3 between the bottom of the well W and the suction port 224a was 0.5 mm, the fact that the event rate was not confirmed when the distance D3 was 0.3 mm is not due to the depletion of the sample in the suspension.

Through the above verification, it was proved that when the distance D3 between the bottom of the well W and the suction port 224a was set in the range of 0.4 mm or more and 0.8 mm or less, the precipitate of the sample was sufficiently suctioned, and the precipitate of the samples was hardly suctioned outside the above range. That is, the effect of setting the distance D3 in the range of 0.4 mm or more and 0.8 mm or less was proved.

1.4) Effects

According to the first embodiment, the bottom of the well W and the suction port 224a are controlled to be separated from each other by a predetermined distance by the control of the controller 25. Specifically, the distance D3 is controlled to be 0.5 mm. Therefore, since an event is constantly detected if the distance D3 is 0.4 mm or more and 0.8 mm or less as verified above, the precipitate of the sample precipitated at the bottom of the well W is sufficiently suctioned if the distance D3 is 0.5 mm (see FIG. 10).

### 2. Second Embodiment

Next, a sample liquid-sending device 20 according to a second embodiment of the present technology will be described. Hereinafter, similar reference symbols are assigned to the similar configurations as in the first embodiment, and description thereof will be omitted.

2.1) Nozzle Configuration

### 2.1.1) Application Example 1

A nozzle 224 in the second embodiment may have an opening 224c. FIG. 11 is an enlarged side view of the periphery of a suction port 224a of the nozzle 224, and FIG. 12 is an enlarged diagram of the suction port 224a (bottom surface S2) as viewed from the Z-axis direction.

As shown in FIG. 11, the opening 224c is provided at the tip of the suction port 224a of the nozzle 224, and communicates with a hollow portion 224b that is a flow path through which the suspension flows. As shown in FIG. 12, the opening 224c is a groove formed linearly along the Y-axis direction. Note that the opening 224c shown in FIG. 11 has a rectangular opening shape, but the shape is not limited thereto. The shape of the opening 224c may be triangular, semicircular, or the like.

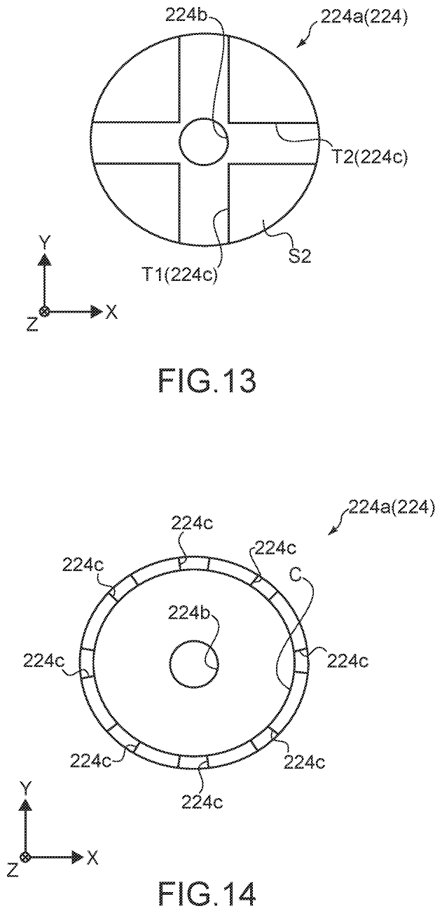

In the present technology, the formation pattern of the opening 224c formed in the suction port 224a is not limited to the pattern shown in FIGS. 11 and 12. FIGS. 13 and 14 are enlarged diagrams of the suction port 224a (bottom surface S2) as viewed from the Z-axis direction, and show variations of the formation pattern of the opening 224c.

[Pattern 1]

As shown in FIG. 13, the opening 224c may be configured to include a first groove T1 formed linearly along the Y-axis direction and a second groove T2 formed along the Z-axis direction. That is, the groove may be formed in a cross shape at the tip of the suction port 224a of the nozzle 224.

[Pattern 2]

As shown in FIG. 14, a plurality of openings 224c may be provided around the Z-axis at the tip of the suction port 224a of the nozzle 224. In this case, each of the plurality of openings 224c communicates with a recess C (recessed toward the sample flow tube 225) provided along the Z-axis direction as shown in the figure, and communicates with the hollow portion 224b via the recess C. Note that the number of the openings 224c shown in FIG. 14 is eight, but the number is not limited thereto and may be eight or more or eight or less.

### 2.1.2) Application Example 2

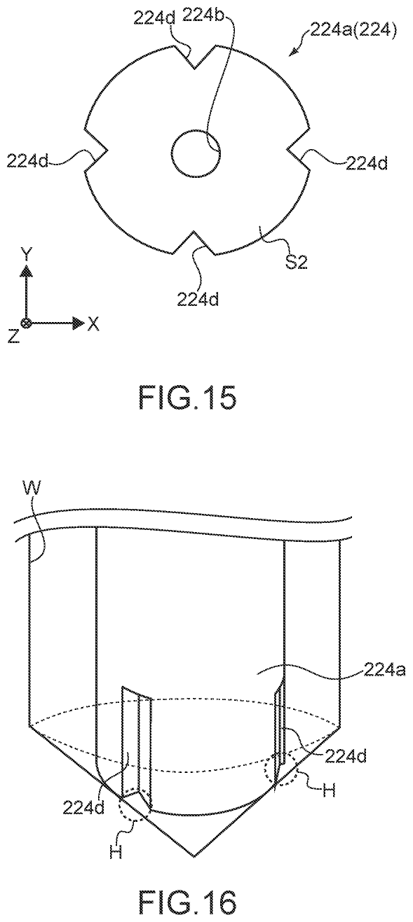

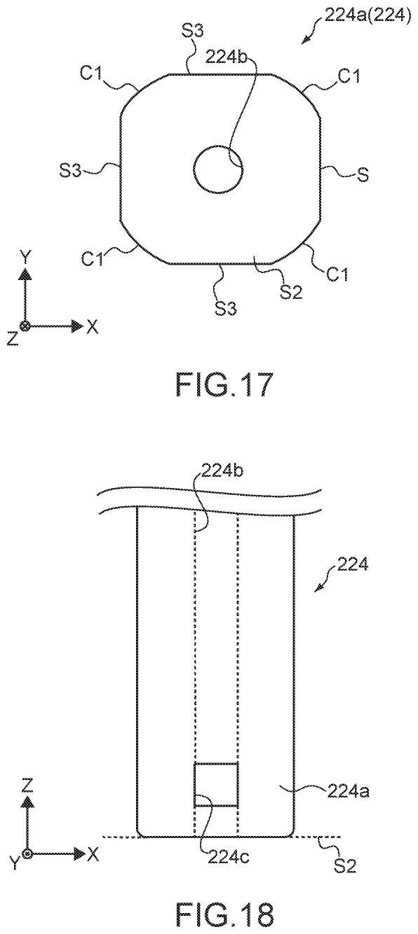

FIGS. 15 and 17 are enlarged diagrams of the bottom surface S2 of the nozzle 224 as viewed from the Z-axis direction. Further, FIG. 16 is an enlarged perspective diagram of the periphery of the suction port 224a and shows the nozzle 224 accommodated in the well W. Note that the bottom surface S2 of the nozzle 224 is a surface facing the bottom of the well W when the suction mechanism 22 suctions the suspension stored in the well W.

[Pattern 1]

The nozzle 224 of the second embodiment may have a configuration in which notches 224d are provided in the bottom surface S2. In this case, as shown in FIG. 15, a plurality of notches 224d is provided around the Z axis. With this configuration, when the suction port 224a is accommodated in the well W that does not have the flat bottom, gaps H are generated between the tip of the suction port 224a and the bottom of the well W, and a flow path for suctioning the suspension is reliably secured. Therefore, it is possible to sufficiently suction the suspension accumulated at the bottom of the well W and to reduce the dead volume.

Note that the shape of the notch 224d shown in FIG. 15 is V-shaped, but the shape is not limited thereto. The shape is not limited to a rectangular shape, a U-shaped shape, and the like. Further, the number of notches 224d shown in the figure is four, but the number is not limited thereto and may be four or more or four or less.

Here, the “dead volume” described above is the amount of a suspension that cannot be suctioned when the suspension is suctioned through the sample nozzle and also has the same meaning in the following description.

[Pattern 2]

In the nozzle 224 of the second embodiment, as shown in FIG. 17, the bottom surface S2 may have a shape of a combination of straight lines S3 and curved lines Cl. With this configuration, the operation and effect similar to those of the pattern 1 of the application example 2 can be obtained. In FIG. 17, each of the number of straight lines S3 and the number of curved lines Cl is four, but it is needless to say that the number is not limited to this.

### 2.1.3) Application Example 3

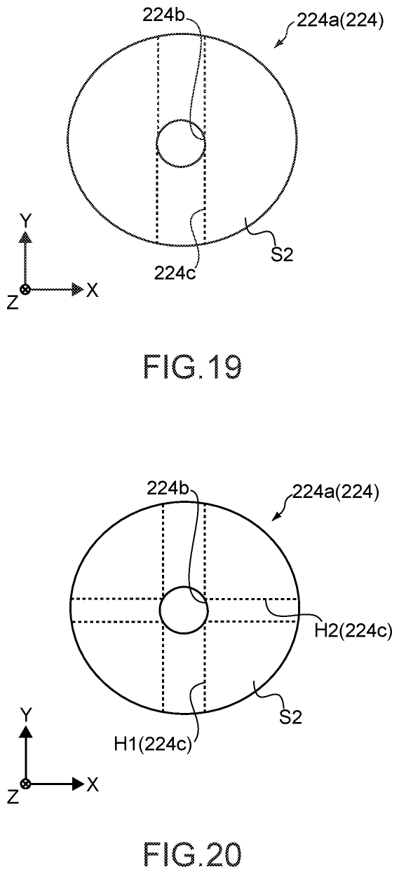

The nozzle 224 of the second embodiment may have a configuration in which an opening 224c is provided in the suction port 224a. The opening 224c is a through-hole that penetrates the side wall near the tip of the suction port 224a. FIG. 18 is an enlarged side view of the periphery of the suction port 224a of the nozzle 224, and FIGS. 19 and 20 are enlarged diagrams of the suction port 224a (bottom surface S2) of the nozzle 224 as viewed from the Z-axis direction.

[Pattern 1]

As shown in FIG. 19, the opening 224c (through-hole) may be configured to be formed linearly along the Y-axis direction and to communicate with the hollow portion 224b. Note that the opening shape of the opening 224c is a rectangular shape, but it is not limited thereto and may be any shape such as a triangular shape, a circular shape, or an elliptical shape.

[Pattern 2]

As shown in FIG. 20, the opening 224c (through-hole) may have a configuration including a first through-hole H1 formed linearly along the Y-axis direction and communicating with the hollow portion 224b and a second through-hole H2 formed along the X-axis direction and communicating with the hollow portion 224b. Note that in the pattern 2, the opening 224c includes two through-holes, but it is not limited thereto and may include two or more through-holes.

2.2) Operation of Sample Liquid-Sending Device

The sample liquid-sending device 20 of the second embodiment suctions the suspension through the nozzle 224 by the suction mechanism 22 in a state where the bottom of the well W and the suction port 224a of the nozzle 224 are in contact with each other. That is, in the operation of the sample liquid-sending device 20 of the second embodiment, Step S105 described in the first embodiment is omitted.

2.3) Verifications

In order to prove the effect in the second embodiment, the inventor performed the following verifications 1 and 2. A cell analyzer (product name: SA3800) manufactured by Sony Corporation was used in the verifications. Further, in the verifications, the nozzle 224 having the opening 224c in the suction port 224a was used. In addition, in this verifications, the flow rate at which the suspension is suctioned was set to 33 μL/min.

### 2.3.1) Verification 1

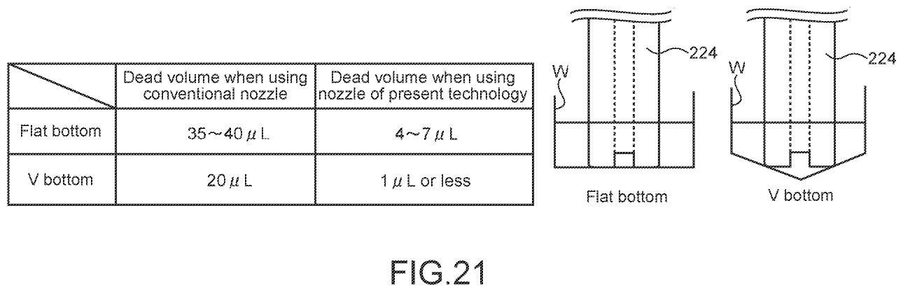

In the verification 1, the nozzle 224 (suction port 224a) was brought into contact with the bottom of the well W, and it was confirmed how much dead volume existed when the suspension was suctioned through the nozzle 224. In the verification 1, a conventional nozzle having no opening 224c was used as a comparative example, and the cases where the well W has a flat bottom and has a V bottom were verified. FIG. 21 is a table summarizing the verification results.

Referring to FIG. 21, in a conventional method of suctioning a suspension through the nozzle having no opening 224c with a certain distance (e.g., 1 mm or more and 1.2 mm or less) between the tip of the nozzle and the bottom of the well, the dead volume was 35 to 40 μL in the case of the well having a flat bottom, and was 20 μL in the case of the well having a V bottom.

On the other hand, in this method of suctioning a suspension through the nozzle 224 having the opening 224c in the suction port 224a with the suction port 224a and the bottom of the well W being in contact with each other, the dead volume was 4 to 7 μm in the case of the well W having a flat bottom, and was 1 μm or less in the case of the well W having a V bottom.

Through the above verification, it was confirmed that the dead volume can be clearly reduced compared to the conventional method by bringing the suction port 224a having the opening 224c into contact with the bottom of the well W and suctioning the suspension through the nozzle 224. That is, the effect of forming the opening 224c in the suction port 224a was proved.

### 2.3.2) Verification 2

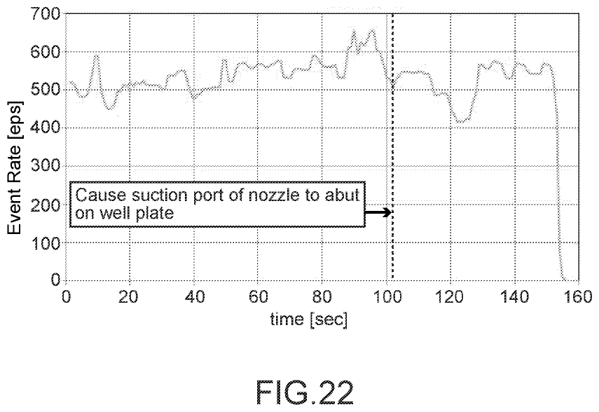

In the verification 2, it was checked whether or not the event rate (events per second; eps) is changed before and after the suction port 224a is brought into contact with the bottom of the well W. FIG. 22 is a graph showing results of the verification. In the verification 2, the suction port 224a was brought into contact with the bottom of the well W approximately 100 seconds after the start of the suction of the suspension. In this case, a suspension containing sample beads (flow check beads) of a dried inorganic material as samples in deionized water (DIW) is stored in the well W. Further, the event rate is the number of samples detected by the sample detection unit 23 per second.

Referring to FIG. 22, it was confirmed that the event rate did not change even when the suction port 224a and the bottom of the well W were brought into contact with each other. That is, this verification proved that the event rate is not affected even if the suspension is suctioned through the nozzle 224 having the opening 224c in the suction port 224a while the suction port 224a and the bottom of the well W are in contact with each other.

2.4) Effects

According to the second embodiment of the present technology, the opening 224c is provided in the suction port 224a of the nozzle 224. As a result, the suspension can be suctioned in a state where the suction port 224a and the bottom of the well W are in contact with each other, so that the dead volume can be reduced (see FIG. 21). In particular, when a plurality of openings 224c is provided in the suction port 224a (see FIGS. 13, 14, and 20), the efficiency in suctioning the suspension is improved.

### 3. Modified Examples

Although the embodiments of the present technology have been described above, the present technology is not limited to the embodiments described above and can be variously modified.

For example, in the above embodiments, the controller 25 controls the distance D3 between the suction port 224a of the nozzle 224 and the bottom of the well W, but the present technology is not limited thereto. The distance D3 may be controlled by a manual operation by a person, for example.

Further, in the above embodiments, the drive mechanism (support portion 211) for supporting the well plate P is moved so as to control the distance D3 between the suction port 224a and the bottom of the well W, but the present technology is not limited thereto. For example, the distance D3 may be controlled by moving the nozzle arm 241 for supporting the nozzle holder 242.

Furthermore, in the above embodiments, Step S104 is typically executed for all the wells W, but the present technology is not limited thereto. For example, Step S104 may be executed for every 3 or 4 wells or may be omitted as necessary.

In addition, in this specification, the “suction port” of the nozzle 224 conceptually includes at least the tip of the nozzle 224 facing the bottom of the well W when the suspension is suctioned, and the side wall near the tip.

Further, in the above embodiments, the example in which the sample liquid-sending device 20 is applied to a flow cytometer has been described, but the present technology is not limited thereto. The sample liquid-sending device 20 may be applied as, for example, a sorter, and may be used for any purpose.

Note that the present technology may take the following configurations.

(1) A sample liquid-sending device, including:

a drive mechanism that supports a sample container and is configured to be capable of moving the sample container, the sample container including a storing portion that stores a suspension containing a sample;

a suction mechanism that includes a nozzle configured to be inserted into the storing portion, and suctions the suspension through the nozzle; and

a controller configured to be capable of controlling the drive mechanism such that a bottom of the storing portion and a suction port of the nozzle are separated from each other by a predetermined distance.

(2) The sample liquid-sending device according to (1), in which the controller controls a distance between the bottom and the suction port to be 0.4 mm or more and 0.8 mm or less.
(3) The sample liquid-sending device according to (1) or (2), in which

the suction mechanism includes the nozzle including a hollow portion and an opening, the hollow portion being a flow path through which the suspension flows, the opening being provided in the suction port and communicating with the hollow portion.

(4) The sample liquid-sending device according to (3), in which

the suction mechanism includes the nozzle including a plurality of openings provided in the suction port and communicating with the hollow portion.

(5) The sample liquid-sending device according to any one of (1) to (4), in which

the suction mechanism includes the nozzle including a notched bottom surface facing the bottom.

(6) The sample liquid-sending device according to any one of (1) to (5), further including

a holding mechanism including a detection unit that detects a contact between the bottom and the suction port, and configured to be capable of holding the nozzle at a predetermined position.

(7) A flow cytometer, including:

a drive mechanism that supports a sample container and is configured to be capable of moving the sample container, the sample container including a storing portion that stores a suspension containing a sample;

a suction mechanism that includes a nozzle configured to be inserted into the storing portion, and suctions the suspension through the nozzle;

a controller configured to be capable of controlling the drive mechanism such that a bottom of the storing portion and a suction port of the nozzle are separated from each other by a predetermined distance;

a holding mechanism including a detection unit that detects a contact between the bottom and the suction port, and configured to be capable of holding the nozzle at a predetermined position; and

an analysis unit that analyzes a characteristic of the sample.

(8) A sample liquid-sending method, including:

inserting a nozzle provided to a suction mechanism into a storing portion of a sample container supported by a drive mechanism, a suspension containing a sample being stored in the storing portion;

detecting a contact between a bottom of the storing portion and a suction port of the nozzle;

separating the storing portion and the suction port from each other by a predetermined distance; and

suctioning the suspension through the nozzle by the suction mechanism.

(9) A sample liquid-sending method, including:

inserting a nozzle provided to a suction mechanism into a storing portion of a sample container supported by a drive mechanism, a suspension containing a sample being stored in the storing portion;

detecting a contact between a bottom of the storing portion and a suction port of the nozzle; and

suctioning the suspension through the nozzle by the suction mechanism in a state where the bottom and the suction port are in contact with each other.

### REFERENCE SIGNS LIST

20 sample liquid-sending device
21 drive mechanism
22 suction mechanism
24 holding mechanism
25 controller
100 flow cytometer
224 nozzle
224a suction port
224b hollow portion
224c opening
224d notch
243 detection unit

1. A sample liquid-sending device, comprising:
a drive mechanism that supports a sample container and is configured to be capable of moving the sample container, the sample container including a storing portion that stores a suspension containing a sample;
a suction mechanism that includes a nozzle configured to be inserted into the storing portion, and suctions the suspension through the nozzle; and
a controller configured to be capable of controlling the drive mechanism such that a bottom of the storing portion and a suction port of the nozzle are separated from each other by a predetermined distance.

2. The sample liquid-sending device according to claim 1, wherein
the controller controls a distance between the bottom and the suction port to be 0.4 mm or more and 0.8 mm or less.

3. The sample liquid-sending device according to claim 1, wherein
the suction mechanism includes the nozzle including a hollow portion and an opening, the hollow portion being a flow path through which the suspension flows, the opening being provided in the suction port and communicating with the hollow portion.

4. The sample liquid-sending device according to claim 3, wherein
the suction mechanism includes the nozzle including a plurality of openings provided in the suction port and communicating with the hollow portion.

5. The sample liquid-sending device according to claim 1, wherein
the suction mechanism includes the nozzle including a notched bottom surface facing the bottom.

6. The sample liquid-sending device according to claim 1, further comprising
a holding mechanism including a detection unit that detects a contact between the bottom and the suction port, and configured to be capable of holding the nozzle at a predetermined position.

7. A flow cytometer, comprising:
a drive mechanism that supports a sample container and is configured to be capable of moving the sample container, the sample container including a storing portion that stores a suspension containing a sample;
a suction mechanism that includes a nozzle configured to be inserted into the storing portion, and suctions the suspension through the nozzle;
a controller configured to be capable of controlling the drive mechanism such that a bottom of the storing portion and a suction port of the nozzle are separated from each other by a predetermined distance;
a holding mechanism including a detection unit that detects a contact between the bottom and the suction port, and configured to be capable of holding the nozzle at a predetermined position; and
an analysis unit that analyzes a characteristic of the sample.

8. A sample liquid-sending method, comprising:
inserting a nozzle provided to a suction mechanism into a storing portion of a sample container supported by a drive mechanism, a suspension containing a sample being stored in the storing portion;
detecting a contact between a bottom of the storing portion and a suction port of the nozzle;
separating the storing portion and the suction port from each other by a predetermined distance; and
suctioning the suspension through the nozzle by the suction mechanism.

9. A sample liquid-sending method, comprising:
inserting a nozzle provided to a suction mechanism into a storing portion of a sample container supported by a drive mechanism, a suspension containing a sample being stored in the storing portion;
detecting a contact between a bottom of the storing portion and a suction port of the nozzle; and
suctioning the suspension through the nozzle by the suction mechanism in a state where the bottom and the suction port are in contact with each other.
